(19) United States
(12) Patent Application Publication
(10) Pub. No.: US 2012/0001371 A1
(43) Pub. Date: Jan. 5, 2012

(54) Method for Producing a Ceramic Filter Element

(75) Inventors: Jochen Linhart, Schwaikheim (DE); Sabine Otterbach, Bietigheim-Bissingen (DE); Kathrin Lichtenwalter, Gerlingen (DE); Kathrin Fischer, Leutenbach (DE)

(73) Assignee: MANN+HUMMEL GMBH, Ludwigsburg (DE)

(21) Appl. No.: 13/206,128

(22) Filed: Aug. 9, 2011

Related U.S. Application Data
(63) Continuation of application No. PCT/EP2010/051617, filed on Feb. 10, 2010.
Application No. PCT/EP2010/051617 is a continuation-in-part of application No. 13/033,979, filed on Feb. 24, 2011.
Application No. 13/033,979 is a continuation-in-part of application No. 11/651,544, filed on Jan. 10, 2007, now Pat. No. 7,913,377.

(30) Foreign Application Priority Data
Jul. 10, 2004 (DE) 102004033494.3
Feb. 10, 2009 (DE) 102009008300.6

(51) Int. Cl. C04B 33/28; C04B 33/32

(52) U.S. Cl. 264/629

(57) ABSTRACT

The invention relates to a method for producing a ceramic filter element in an exhaust gas filter for internal combustion engines, wherein a wound paper element that comprises flow channels on one or both sides that are sealed on alternating sides with a ceramic plugging is formed, soaked with a ceramic slip, and then dried and sintered. The ceramic plugging is applied with an inward offset from the end face of the wound paper element.

### CROSS REFERENCE TO RELATED APPLICATIONS

This application is a bypass continuation application of currently pending international application No. PCT/EP2010/051617 filed Feb. 10, 2010 designating the United States of America, the entire disclosure of which is incorporated herein by reference. Priority is claimed based on German patent application no. 10 2009 008 300.6, filed Feb. 10, 2009.

The present application is a continuation in part (CIP) of and claims priority to currently pending U.S. patent application Ser. No. 13/033,979 filed Feb. 24, 2011, the entire contents of U.S. patent application Ser. No. 13/033,979 incorporated herein by reference. U.S. patent application Ser. No. 13/033,979 is a continuation in part (CIP) of U.S. patent application Ser. No. 11/651,544 (now U.S. Pat. No. 7,913,377) which is a continuation of international patent application no. PCT/EP2005/052884, filed Jun. 21, 2005, designating the United States of America, and published in German on Jan. 19, 2006 as WO 2006/005668 which claims priority from German patent application no. 102004033494.3, filed Jul. 10, 2004. U.S. patent application Ser. No. 13/033,979 further claims priority from U.S. patent application Ser. No. 11/945,371 filed Nov. 27, 2007 which claims priority from Federal Republic of Germany patent application no. 102006056196.1, filed Nov. 27, 2006.

### TECHNICAL FIELD

The invention relates to a method for producing a ceramic filter element in an exhaust gas filter of an internal combustion engine.

### BACKGROUND OF THE INVENTION

In Patent Abstracts of Japan JP 63134020 A, a ceramic filter element for an exhaust gas filter in an internal combustion engine is disclosed that is constructed of a corrugated spirally wound filter web. For producing the filter web, heat-resistant inorganic fibers are mixed in aqueous suspension with ceramic powder and processed to a web. Several stacked webs are rolled to the desired shape of the filter body whereby between neighboring filter webs honeycomb-shaped flow passages are formed. The filter body is subsequently fired at high temperature.

WO 2006/005668 discloses a method for producing a ceramic filter element in an exhaust gas filter for internal combustion engines. In this connection, first a combustible non-ceramic support web is impregnated with a ceramic slip and, subsequently, burned out in the desired geometric shape until the support web is combusted and a rigid filter body is generated.

The invention concerns in particular the manufacture of ceramic filter elements as diesel particulate filters and particulate filters for internal combustion engines as well as ceramic supports for catalyst supports.

In the method that is preferred in the invention a non-ceramic medium, for example, paper, in particular paper comprising cellulose, is first shaped, for example, to the shape of a coil body. The coil body can comprise a flat layer and a corrugated layer. This shape, for example, the coil body, is then impregnated with a ceramic material, for example, a ceramic slip. The impregnated shape is then fired or sintered. In this connection, organic components, for example, of the paper that comprises e.g. cellulose fibers, can be removed or converted.

Honeycomb-shaped ceramic filter elements have excellent heat resistance and are therefore used as catalyst supports for automobile exhaust gases and as filters for trapping soot in the exhaust gas of a diesel engine.

In order to produce a filter body with a honeycomb structure in cross-section, in which in axial direction of the filter body flow passages for the exhaust gas to be purified are formed, two stacked support webs can be connected or glued to each other wherein at least one of the two support webs is rippled or corrugated in order to produce the aforementioned flow passages (semi-finished product manufacture). The support webs are preferably embodied as paper webs and are comprised of cellulose. However, also other organic or inorganic substances that are combustible are conceivable. The two stacked support webs can be coiled on a winding machine to a substantially cylindrical filter body that forms a coil filter. Of course, also other geometric shapes and figures are possible.

For the use as a filter element, an alternating closure of the passages is required wherein the aforementioned method has the advantage that the closure can be already introduced during manufacture of the paper elements and no additional subsequent manufacturing process is required, as is the case, for example, for extruded honeycomb bodies.

The material employed for closing off the passages and referred to as pouring compound, ceramic glue or ceramic plugging must be embodied such that after sintering a seal-tight closure is ensured. The plugging is usually applied immediately at one or both end faces of the filter element.

As already disclosed, the paper coil body, including the ceramic plugging, is impregnated with a ceramic slip, subsequently dried and then sintered. When doing so there is the risk that slip material that is dripping down will also close off passages at the end that is to stay open.

### SUMMARY OF THE INVENTION

It is therefore the object of the present invention to provide a method for producing a ceramic filter element in an exhaust gas filter of an internal combustion engine that prevents that the flow passages become closed off by dripping material during the manufacturing process.

It is a further object of the present invention to provide a method such that a problem-free manufacture of flawless components is enabled.

These and further objects are solved by the method for producing a ceramic filter element according to claims presented herein.

As already mentioned, the ceramic plugging is applied usually at the end face of the flow passages.

According to the invention it is now proposed that the plugging is not applied in the paper coil body immediately at the end face but is applied inwardly displaced. In this connection, it has been found to be advantageous to maintain a spacing of approximately 1 to 2 cm away from the end face of the coil body.

During impregnation and the subsequent dripping off step, the coil body is placed onto the side where the plugging is displaced inwardly. It is also possible to provide both sides of the coil body with inwardly displaced plugging.

After drying or after the sintering process the paper coil body is then separated exactly at the bottom side of the inwardly displaced plugging. This can be achieved, for example, by sawing. In this way, the filled-up area of the coil is removed and all flow passages are free.

When the separating step is carried out immediately after drying (and before sintering), the disk of the coil body that is cut off can be used as a separate firing support (cookie) in order to prevent damage of the support side of the component as a result of sinter shrinkage.

When the separating step is carried out after sintering, a quality advantage results also. Because of sintering shrinkage the support side can also be damaged here, but it is then cut off and a flawless component is enabled in this way.

In at least one aspect of the invention, the method for producing a ceramic exhaust filter element or catalyst support element includes the steps of

providing at least one combustible, non-ceramic, paper sheet;

rolling the at least one sheet to form an axial flow paper coiled body having axial flow channels extending between opposing end faces of the coiled body;

applying ceramic plugging into at least a portion of the axial flow channels, each ceramic plug arranged at a location spaced axially inwardly away from a nearest one of the end faces, wherein each ceramic plug provides closure to its respective axial flow channel;

impregnating the coiled body with a ceramic slip; and thereafter

drying the coiled body; and

sintering the coiled body forming a rigid ceramic filter element, wherein in the sintering the at least one sheet is removed from the ceramic filter body by combustion.

After the sintering step the ceramic plugs remain within the ceramic filter element providing seal-tight closure of respective flow channel into which the plug is arranged.

One or more of the at least one combustible paper sheets may be corrugated to provide flow the above mentioned flow channels when coiled into the filter body.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

FIG. 1 depicts a detail of a filter element or its blank before impregnation with ceramic slip, consistent with the present invention; and

FIG. 2 depicts a detail of a filter element or its blank before cutting off the lower area, consistent with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of apparatus components and method steps related to a method for producing a ceramic filter element. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

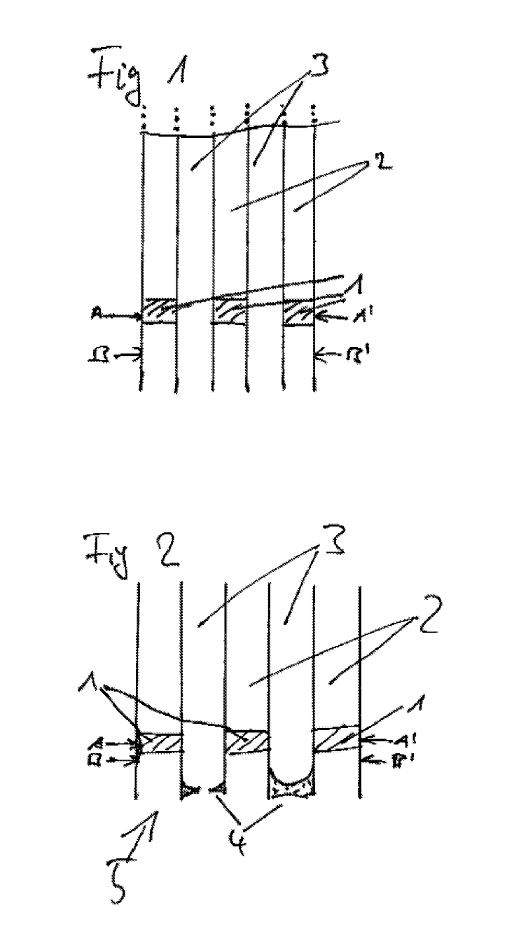

In FIG. 1 a detail of a coil body is shown having one group of passages (2) closed off with plugs (1). The other group of passages (3) can be closed off at the other side of the coil body that is not illustrated in the detail view.

In FIG. 2, the detail of the coil body after impregnation with slip is illustrated. At the lower end one can see the closed-off or partially closed-off passages of the (3) that should be open. By separating along the line A-A′ or B-B′ these closures can be removed. At the same time, possible damage at the side 5 that may have been caused by handling can also be removed. Depending on the conditions, a separation exactly at the bottom side of the plugs (1), within the plugs (1) along the line A-A′, or below the plugs (1) along the line B-B′ is to be preferred.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims The invention is defined solely by the appended claims including any amendments made during the pendency of this application and all equivalents of those claims as issued.

1. A method for producing a ceramic exhaust filter element or catalyst support element, comprising:
forming a paper coiled body that has flow passages alternatingly closed off by ceramic plugging;
impregnating said coiled body with a ceramic slip; and subsequently
drying said coiled body;
sintering said coiled body,
wherein said ceramic plugging is applied so as to be inwardly displaced away from a nearest end face of the paper coiled body.

2. The method according to claim 1, wherein
after said drying step said method further comprises
separating said coiled body into a first and second coiled body portions at a predefined axial location,
wherein said predefined axial location is any of: an axial location exactly at the outwardly facing axial side of said plugging, at an axial location positioned between inwardly and outwardly facing sides of said plugging, at an axial location positioned between said outwardly facing sides of said plugging and said nearest end face of said coiled body.

3. The method according to claim 2, wherein in that the separation is carried out by means of a sawing step.

4. The method according to claim 1, wherein
after said sintering step said method further comprises
separating said coiled body into a first and second coiled body portions at a predefined axial location,
wherein said predefined axial location is any of: an axial location exactly at the outwardly facing axial side of said plugging, at an axial location positioned between inwardly and outwardly facing sides of said plugging, at an axial location positioned between said outwardly facing sides of said plugging and said nearest end face of said coiled body.

5. The method according to claim 4, wherein in that the separation is carried out by means of a sawing step.

6. The method according to claim 1, wherein
said ceramic plugging is displaced axially inwardly into said coiled body spaced from said nearest end face by approximately 1-2 cm.

7. A method for producing a ceramic exhaust filter element or catalyst support element, comprising:
providing at least one combustible, non-ceramic, paper sheet;
rolling said at least one sheet to form an axial flow paper coiled body having axial flow channels extending between opposing end faces of said coiled body;
applying ceramic plugging into at least a portion of said axial flow channels, each ceramic plug arranged at a location spaced axially inwardly away from a nearest one of said end faces, wherein each ceramic plug provides closure to its respective axial flow channel;
impregnating said coiled body with a ceramic slip; and thereafter
drying said coiled body;
sintering said coiled body forming a rigid ceramic filter element, wherein in said sintering said at least one sheet is removed from said ceramic filter body by combustion,
wherein after said sintering step each ceramic plug remains within said ceramic filter element providing seal-tight closure of its respective flow channel.

8. The method according to claim 7, wherein
after said drying step said method further comprises
separating said coiled body into a first and second coiled body portions at a predefined axial location,
wherein said predefined axial location is any of: an axial location exactly at the outwardly facing axial side of said plugging, at an axial location positioned between inwardly and outwardly facing sides of said plugging, at an axial location positioned between said outwardly facing sides of said plugging and said nearest one of said end faces.

9. The method according to claim 8, wherein
in said separating step, said separating comprises
sawing through said coiled body at said predefined axial location.

10. The method according to claim 7, wherein
after said sintering step said method further comprises
separating said coiled body into a first and second coiled body portions at a predefined axial location;
wherein said predefined axial location is any of: at an axial location exactly at the outwardly facing axial side of said plugging, at an axial location positioned between inwardly and outwardly facing sides of said plugging, at an axial location positioned between said outwardly facing sides of said plugging and said nearest one of said end faces.

11. The method according to claim 10, wherein
in said separating step, said separating comprises
sawing through said coiled body at said predefined axial location

12. The method according to claim 7, wherein
said ceramic plugging is displaced axially inwardly into said coiled body spaced from said nearest end face by approximately 1-2 cm.

13. The method according to claim 7, wherein
a first portion of said axial flow channels are closed by said inwardly displaced plugging proximate to a first one of said end faces,
a second portion of said axial flow channels are closed by said inwardly displaced plugging proximate to an opposing second one of said end faces,
wherein said axial flow channels of said ceramic filter body are alternatingly closed off,
wherein said ceramic filter body forms a diesel particulate filter in which all axial flow channels are sealingly closed by plugging on at least at one end of each axial flow channel.
